(19) United States
(12) Patent Application Publication
(10) Pub. No.: US 2010/0126944 A1
(43) Pub. Date: May 27, 2010

(54) Treatment of Water Contaminated with Energetic Compounds

(76) Inventors: Washington Braida, Edgewater, NJ (US); Christos Christodoulatos, Basking Ridge, NJ (US); Per Arienti, Allendale, NJ (US); Gregory O'Connor, Rockaway Twp., NJ (US); Benjamin Smolinski, Rockaway, NJ (US)

Correspondence Address: GREENBERG TRAURIG, LLP, 200 PARK AVE., P.O. BOX 677, FLORHAM PARK, NJ, 07932, US

(21) Appl. No.: 12/581,480

(22) Filed: Oct. 19, 2009

Related U.S. Application Data
(60) Provisional application No. 61/106,641, filed on Oct. 20, 2008.

(51) Int. Cl. C02F 1/68

(52) U.S. Cl. 210/749

(57) ABSTRACT

Organic nitro compounds, especially nitro aromatic compounds and nitramines, in water are degraded through contact with bimetallic particles comprising cores of zero-valent iron having discontinuous coatings of metallic copper on the surfaces thereof. Higher rates of degradation are achieved when the water has a pH in the range of about 3.5 to about 4.5, especially when acetic acid is present in the water.

### CROSS-REFERENCE TO RELATED APPLICATION

This application claims the benefit of U.S. Provisional Patent Application No. 61/106,641, filed on Oct. 20, 2008, which is incorporated herein by reference for all purposes.

### STATEMENT REGARDING FEDERALLY FUNDED RESEARCH

The disclosed invention was developed at least in part under U.S. Army contract W15QKN-05-D-0011, Task Order #24 and Task Order #49, by the Armament Research Development and Engineering Center (ARDEC). The government of the United States of America may have certain rights in this invention.

### FIELD OF THE INVENTION

The present invention pertains to the field of wastewater treatment, in particular, to the electrochemical degradation of energetic compounds in water.

### BACKGROUND OF THE INVENTION

The increased use of explosives has resulted in widespread contamination of soils and groundwater with energetic compounds that have proven to be toxic to various terrestrial and aquatic creatures. The manufacture of explosives creates copious amounts of wastewater containing such compounds that must be stored or discharged. Energetic organic compounds used in explosives, especially nitro aromatic and nitramine compounds such as hexahydro-1,3,5-trinitro-1,3,5-triazine (RDX) and others, have proven to be particularly difficult to treat by methods previously known in the art.

Physical-chemical separation processes are being commonly used as remedial technologies for removing nitro compounds from water. Such processes include granular activated carbon adsorption, resin adsorption, liquid-liquid extraction, reverse osmosis, surfactant complexing, and ultrafiltration. Each of these processes concentrates the contaminants in one phase that requires further treatment for landfill disposal.

Oxidative processes employing ozone, hydrogen peroxide, or Fenton's reagent have been reported to be ineffectual in treating RDX contaminated wastewater, even in processes wherein oxidation is promoted by ultraviolet (UV) irradiation. In particular, UV radiation has also been deemed ineffectual in treating RDX-contaminated wastewater because the water often contains cyclohexanone, acetic acid, and nitrate, each of which absorbs strongly in the UV range. A combination of UV and hydrogen peroxide has been shown to be moderately effective in degrading RDX when the wastewater is pretreated anaerobically or with zero-valent iron (ZVI). However, the implementation of such technologies is problematic due to the high capital costs associated with UV photolysis and ozonation.

Alkaline hydrolysis of RDX has been used to desensitize highly concentrated RDX wastes, for example, by addition of surfactants to accelerate the hydrolysis process or by hydrolysis at high pH values at temperatures over 50° C. While such processes are effective on a small scale, a large-scale process would not be economically feasible based on the reaction kinetics of hydrolysis under such conditions.

Microorganisms have been used for decades to treat municipal and industrial wastes. The potential advantages of biological treatment include low cost, ease of operation and public acceptance. However, metabolically unreactive substrates can require excessively long residence times and toxic substrates can inactivate the microbial population. For example, the persistence of RDX in soil and groundwater for more than forty years strongly suggests that RDX is not biodegradable under aerobic conditions. Furthermore, although RDX is readily degradable in the presence of suitable organic co-substrates, it is recalcitrant to biodegradation when it is the sole carbon source. It has been observed that degradation of RDX under anaerobic conditions involves the stepwise disappearance of the nitroso derivatives hexahydro-1-nitroso-3,5-dinitro-1,3,5-trazine (MNX), hexahydro-1,3-dinitroso-5-nitro-1,3,5-trazine (DNX), and hexahydro-1,3,5-trinitroso-1,3,5-trazine (TNX), with formaldehyde and methanol forming last. This suggests that the biodegradation of RDX proceeds via a reduction of the nitro groups, destabilizing the compounds and leading to spontaneous hydrolytic ring cleavage. Denitrification of RDX also occurs in wastewater containing high nitrate levels. The use of ZVI as a pretreatment agent at low pH (e.g., pH 4.7) greatly enhances the biodegradability of RDX.

ZVI has proven to be effective in treating both soil and water contaminated with various organic and inorganic compounds, including pesticides, chlorinated solvents such as trichloroethylene (TCE) and perchlorate, chromate, and arsenic. The ZVI process involves the corrosion of the ZVI surface: as the ZVI corrodes, electrons are transferred from it to the contaminant, causing reductive dehalogenation and hydrogenation reactions. The reaction conditions are also favorable for the degradation of nitro aromatic compounds. The long-term effectiveness of the ZVI treatment, however, is decreased by the formation of oxides on the surface of the ZVI during the corrosion process, changes in the surface area of the ZVI, the presence of nitrate or carbonate in the water and elevation of the reaction pH. In order to overcome these issues, research efforts shifted to nanoscale and bimetallic ZVI.

Over the past few years, nanoscale ZVI (ZVIN) treatment has been explored as a way of degrading compounds traditionally treated with ZVI having larger particle size to increase reaction rate, as well as to improve the long-term effectiveness of ZVI treatment. While ZVIN treatment has been shown to improve reaction rates, there have been problems with agglomeration of the ZVIN, which effectively increases the particle size of the ZVI and consequently slows the reaction rates. An additional issue is the extremely reactive nature of the nanoscale particles, which presents an explosion hazard when dealing with the degradation of energetic materials.

Bimetallic ZVI particles have been effective in degrading various organic and inorganic compounds. Palladium/nickel catalysts and nanoscale ZVI/nickel particles have been effective in degrading chlorinated solvents, and a bed of ZVI and copper shavings was shown to be effective in treating methylene blue in wastewater. Palladium bimetallic particles have been effective in treating nitroso and nitro compounds at ambient pressure and temperature. The bimetallic system is thought to work by creating a galvanic cell that acts to promote corrosion of the iron. Transition metals (e.g., copper) are effective at inducing and promoting iron corrosion by forming a galvanic couple between the ZVI (anode) and the transition metal (cathode) with the ambient water acting as the salt bridge.

There are a few potential areas of concern in the use of bimetallic particles. Depending on the metal used, there is a risk of secondary contamination, as many of the transition elements (e.g., copper) are considered contaminants themselves. Additionally, using extremely expensive metals like platinum and palladium is not a practical, cost-effective remediation technique.

### SUMMARY OF THE INVENTION

A method of treating water containing organic nitro compounds, particularly wastewaters containing energetic compounds of that type, comprises the steps of contacting the water with bimetallic particles comprising cores of zero-valent iron having discontinuous coatings of metallic copper on their surfaces, and then separating the bimetallic particles from the water. Such treatment is effective in degrading energetic nitro compounds to simple low-energy compounds such as formaldehyde, nitrogen, nitrous oxide and ammonia. Degradation rates are increased at pH values from about 3.0 to about 4.5, and are further increased by the presence of acetic acid in the water undergoing treatment. Other factors affecting the degradation rates are the size of the bimetallic particles, the mass of particles used, and the ratio of copper to iron in the particles.

### BRIEF DESCRIPTION OF THE DRAWINGS

For a better understanding of the present invention, reference is made to the following detailed description of the exemplary embodiments considered in conjunction with the accompanying drawings, in which:

FIG. 1 is a conceptual diagram of the degradation of RDX by bimetallic particles in a water treatment process according to an embodiment of the present invention;

FIG. 2 is a schematic diagram of the proposed degradation pathways for RDX in a water treatment process according to an embodiment of the present invention;

FIG. 3 is a microphotograph of a micron-scale bimetallic particle suitable for use in a water treatment process according to an embodiment of the present invention;

FIG. 4 is a graph illustrating the degradation of tetrahexamine tetranitramine (HMX), RDX and RDX nitroso degradation products in a batch water treatment process according to an embodiment of the present invention;

FIG. 5 is a chromatogram of water containing RDX and HMX before treatment by a water treatment process according to an embodiment of the present invention;

FIG. 6 is a chromatogram of the water of FIG. 5 after treatment by the water treatment process of FIG. 5;

FIG. 7 is a graph illustrating the degradation kinetics of RDX and its nitroso degradation products in a water treatment process in a first bench scale test according to an embodiment of the present invention;

FIG. 8 is a graph illustrating the degradation kinetics of RDX and its nitrosylated degradation products in a water treatment process in a duplicate bench scale test according to an embodiment of the present invention; and

FIG. 9 is a plot illustrating the removal of trinitrotoluene (TNT), RDX and tetrahexamine tetranitramine (HMX) in a water treatment process according to an embodiment of the present invention.

### DETAILED DESCRIPTION OF THE INVENTION

In the exemplary embodiments described herein, the present invention comprises a water treatment process for the reductive degradation of nitrated compounds containing nitro groups. Such compounds include, but are not limited to, hexahydro-1,3,5-trinitro-1,3,5-triazine (RDX), tetrahexamine tetranitramine (HMX), trinitrotoluene (TNT), nitroglycerine, and their reduction products.

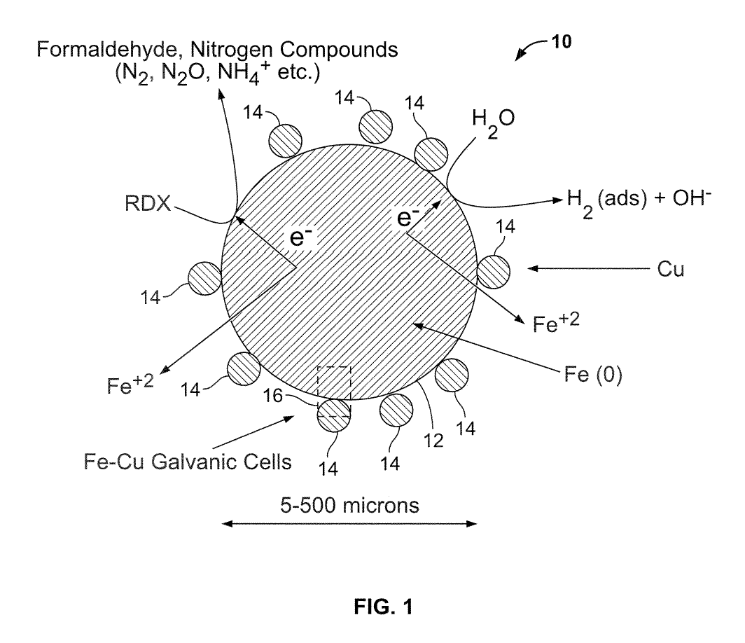

FIG. 1 is a conceptual illustration of the degradation process. Bimetallic particles 10 are provided, each of which comprises a core 12 of zero-valent iron (Fe(0)) (hereinafter, referred to ZVI) having a discontinuous surface coating of metallic copper (Cu), typically in the form of copper islands 14. In acidic solution, the ZVI and metallic copper form a galvanic cell 16, which expedites the corrosion of the ZVI core 12 to form ferrous ions (Fe²⁺) and electrons (e⁻) by known electrochemical reactions. While the ZVI corrodes, the metallic copper is conserved, rather than being dissolved, because of the placement of copper above iron in the standard electrochemical series. The electrons released by oxidation of the ZVI core 12 act to reduce the nitro containing compounds in the solution (e.g., RDX) through a series of degradation products (not shown). The ferrous ions are discharged into the solution, or precipitate in the water or on the surface of the ZVI core in the presence of oxygen. The reduction process ends with the conversion of the energetic compounds to simple low-energy compounds such as formaldehyde (CH₂O), nitrogen (N₂), nitrous oxide (N₂O), and ammonium ion (NH₄⁺).

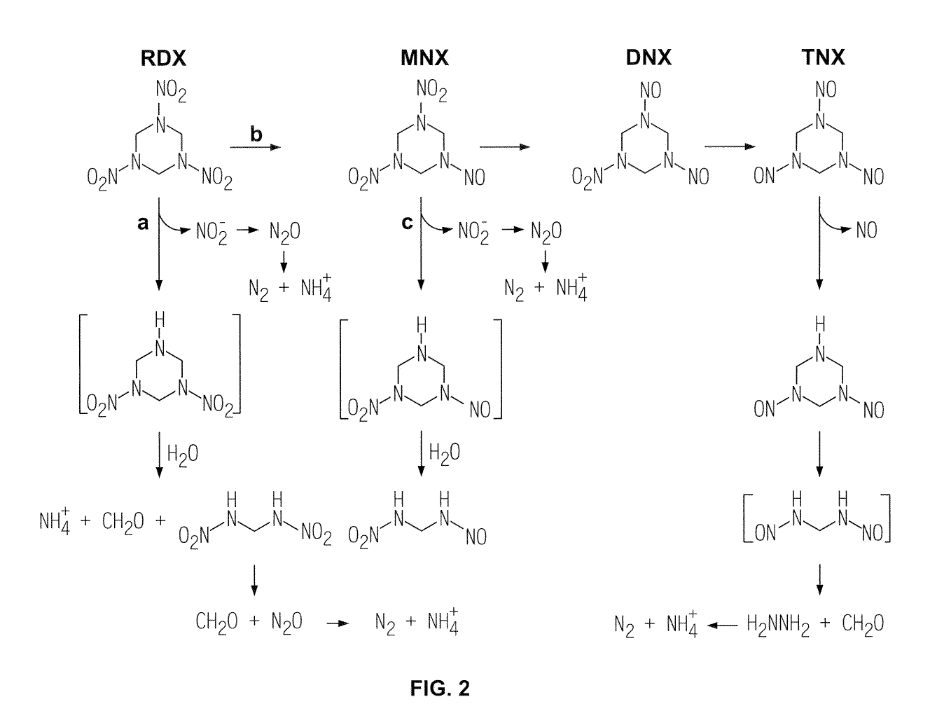

FIG. 2 presents a proposed degradation scheme for RDX in the reductive degradation process discussed with respect to FIG. 1. This scheme was suggested with respect to the degradation of RDX by ZVI in Naja et al., Environmental Science & Technology, 2008, 42, 4364-4370, from which FIG. 2 is adapted. Without being bound by theory, the primary route of degradation is believed to occur along the path labeled “a”, with RDX being sequentially reduced to its reduced nitroso degradation products hexahydro-1-nitroso-3,5-dinitro-1,3,5-triazine (MNX), hexahydro-1,3-dinitroso-5-nitro-1,3,5-triazine (DNX), and hexahydro-1,3,5-trinitroso-1,3,5-triazine (TNX). Experimental evidence of such sequential transformation is discussed hereinbelow. TNX is then further reduced, leading to the eventual destabilization of the triazine ring structure and the formation of the final degradation products, of which CH₂O, N₂ and NH₄⁺ are shown. Modeling studies suggest that a second path of reductive degradation (i.e., the path labeled “b”) also occurs, since the overall removal rate of RDX by the embodiment of the treatment process discussed herein is faster than is suggested by the sequential steps of path “a”. Degradation of MNX along the path labeled “c” is not believed to contribute significantly to the rate of RDX removal.

In an embodiment of the treatment method of the present invention, the pH of water containing nitro compounds, such as RDX, is first adjusted to a pH between 3.0 and 4.5. Typically, the water will have an initial pH greater than 4.5, making it necessary to acidify the water. Mineral or organic acids may be used to effect the pH adjustment; however, acetic acid has been found to be very effective in increasing the rate of the reduction reactions. Without being bound by theory, it is believed that the acetic acid acts as an electron carrier between the ZVI cores and the nitrated compounds in solution. Thus, other electron carriers might be added to the water to increase the reaction rate.

The bimetallic particles of FIG. 1 are then added to the acidic solution at concentrations selected to promote rapid and complete degradation of the nitro compounds. Selection of suitable amounts of particles, as well as their sizes and ZVI/copper compositions, are discussed further hereinbelow. The water is then mixed at speeds sufficient to suspend the particles, but not so great as to entrain significant amounts of air, which would lead to precipitation of iron oxides. Mixing times of less than one hour are often sufficient to degrade the energetic compounds to below detectable levels, but, as will be understood by one having ordinary skill in chemical engineering and comprehension of the present disclosure, the actual time required depends on such factors as solution pH, particle size, particle composition, and the types and initial concentrations of the nitro compounds. The bimetallic particles are then separated from the treated water, which may then be discharged, reused or subjected to further treatment. The bimetallic particles may be reused or disposed of, as appropriate. Iron oxides may be removed from the surfaces of the bimetallic particles by washing the particles with aqueous solutions having pH values below about 4.5.

The mass of bimetallic particles that must be added to the solution in the treatment process discussed above can be estimated through conventional stoichiometric calculations to determine the amount of metal (e.g., the ZVI in the exemplary embodiment under discussion) that must be oxidized to cause the reduction of the nitrated compounds of interest to simple low-energy compounds. These estimates can be refined through routine experimentation to determine the optimum amounts of metal needed to ensure rapid and complete degradation of the nitro compounds. Through such experimentation, it has been found that ZVI/copper bimetallic compounds may be added in amounts of 0.25% to 4.0% of the weight of the solution, depending on the amount and type of nitro compounds to be degraded, without adversely affecting the cost of the treatment process.

It has been found that the size of the bimetallic particles also affects the rate at which the energetic compounds are removed, with smaller diameter particles typically producing greater rates of removal. However, smaller diameter particles raise material handling issues as they may not separate from the solution as readily as larger particles, or may form clumps of particles which reduce the reaction rate. The optimum particle size for a particular treatment regime may be determined by one having ordinary skill in chemical engineering through routine experimentation. Through such experimentation, it has been found that bimetallic ZVI/copper particles having particle sizes in the range of about 5 to about 500 microns may be used effectively in the exemplary treatment process under discussion.

The amount of copper deposited on the surface of the ZVI core should be sufficient to drive the galvanic reaction between the copper and ZVI so that ZVI will be corroded at a sufficiently high rate to cause the rapid degradation of the energetic compounds. It has been found that applying copper in amounts of about 5 gm to about 20 gm for each 100 gm of ZVI is generally sufficient for this purpose. The applicants have discovered that the corrosion process proceeds most effectively when the copper is present as discontinuous islands of metallic copper on the surface of the ZVI core.

The formation of the copper surface coating on the ZVI core is discussed more fully hereinbelow.

The exemplary treatment process under discussion employs bimetallic particles comprising a ZVI core with a surface coating of metallic copper. Bimetallic particles comprising other pairs of metals may be used in other embodiments of the invention as long as the two metals form a galvanic cell that drives the oxidation of one of the metals at a rate sufficient to rapidly and completely degrade the nitro compounds of interest. Such metal pairs can be identified by applying well-known principles of electrochemistry. However, environmental concerns suggest the use of the ZVI/copper pair for decontamination of water because iron is generally not an element of environmental concern and can be readily removed from water. Copper, although sometimes an element of environmental concern, does not dissolve to more than a few parts-per-billion in water in the exemplary process described herein. Further, both ZVI and copper are relatively low-cost materials compared to other metals that may be used in other embodiments of the process and are readily available in large quantities.

Turning to the preparation of the bimetallic particles, a copper surface coating may be applied to the ZVI core through known methods, such as electroless plating or other deposition processes known in the art. The bimetallic particles used in the examples described hereinbelow were prepared by electroless plating. To produce one typical batch of bimetallic particles, a plating solution was prepared by adding 39 g of copper sulfate pentahydrate to 1 L of deionized water (equivalent to 10 g Cu/L). A 100 gm portion of micron-size ZVI particles was added to the plating solution, stirred constantly, and allowed 10 minutes of contact time. The coated particles were then filtered and washed with three 50 mL aliquots of deionized water, followed by three 50 mL aliquots of absolute ethanol and three 50 mL aliquots of acetone. The particles were then dried under vacuum. The particles were then stored in a plastic bottle under nitrogen gas. Bimetallic particles have also been successfully prepared by similar methods using plating solutions of other copper salts at concentrations of 10 g Cu/L or 5 g Cu/L. Bimetallic particles can be prepared from ZVI particles that have been pre-washed to remove surface oxides and from unwashed ZVI particles and still be effective in the exemplary treatment process discussed herein.

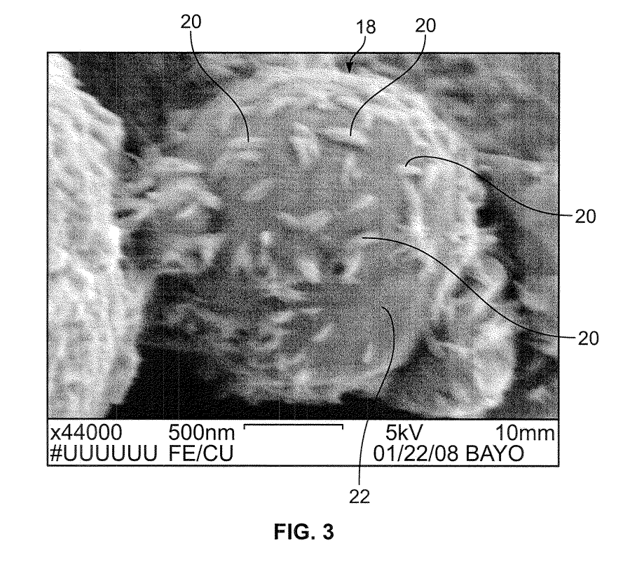

FIG. 3 shows a typical bimetallic particle 18 produced by the method described above showing the discontinuous islands 20 of copper metal desired for the exemplary embodiment of the present invention. Such copper islands 20 are distributed over the entire ZVI core 22. For clarity, only some of the islands 20 have been labeled.

The following Examples illustrate the application of the embodiment of the treatment process discussed herein. These Examples provide guidance as to the applicability of the present embodiment of the treatment process, and variations thereof may be realized by one having ordinary skill in chemical engineering and comprehension of the disclosures made herein. Such variations may include the adaptation of the exemplary processes to full-scale batch treatment systems or continuous-flow treatment systems including those employing fixed:bed or fluidized-bed reactors, or the use of particle separators, such as eductors or hydrocyclones, to separate bimetallic particles from the treated water.

### Example 1

### Treatment of Water Containing RDX and HMX in a Pilot Scale Batch Reactor

A pilot-scale test of the exemplary method was performed on an industrial waste water collected at the Holston Army Ammunition Plant in Kingston, Tenn. (“the Holston water”). The Holston water was the combination of aqueous streams of several explosives production buildings, collected upstream of the Holston waste water treatment plant. The water contained RDX and HMX.

About 7.5 gallons (28.4 L) of the Holston water was pumped into a 15-gallon polyethylene tank and adjusted to a pH of about pH 4 by adding 200 mL of dilute acetic acid solution. A 40 mL sample of the acidified water was collected and labeled as “feed”. Bimetallic ZVI/copper particles, prepared as discussed above, were added to the water in an amount of 1% of the weight of solution. The particles were suspended in the water by stirring at about 850-900 rpm, and filtered samples of 3 mL each were collected at contact times of 0, 1, 2, 5, 15 and 30 minutes. After 75 minutes of stirring, the particles were allowed to settle for 45 minutes, after which water samples were collected from the top and bottom of the container. All samples were then analyzed by high-performance liquid chromatography (HPLC). For subsequent batches, first enough of the treated water from the previous batch was removed to leave 2-2.5 gal of water in the reactor, then about 5 gal of untreated water was added, and the treatment process was repeated, acidifying only alternate batches of water.

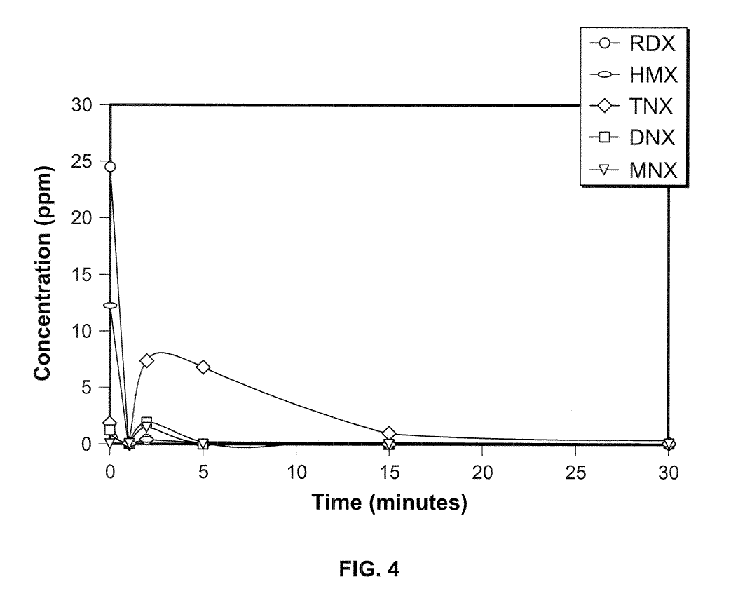

FIG. 4 is a graph of the concentrations of RDX, HMX, and the RDX reduction products TNX, DNX and MNX over time in one cycle of the batch reaction. RDX, HMX and the RDX reduction products were removed to undetectable levels before 30 minutes of treatment time elapsed. The plots of TNX, DNX and MNX concentrations show the formation and subsequent removal of these compounds.

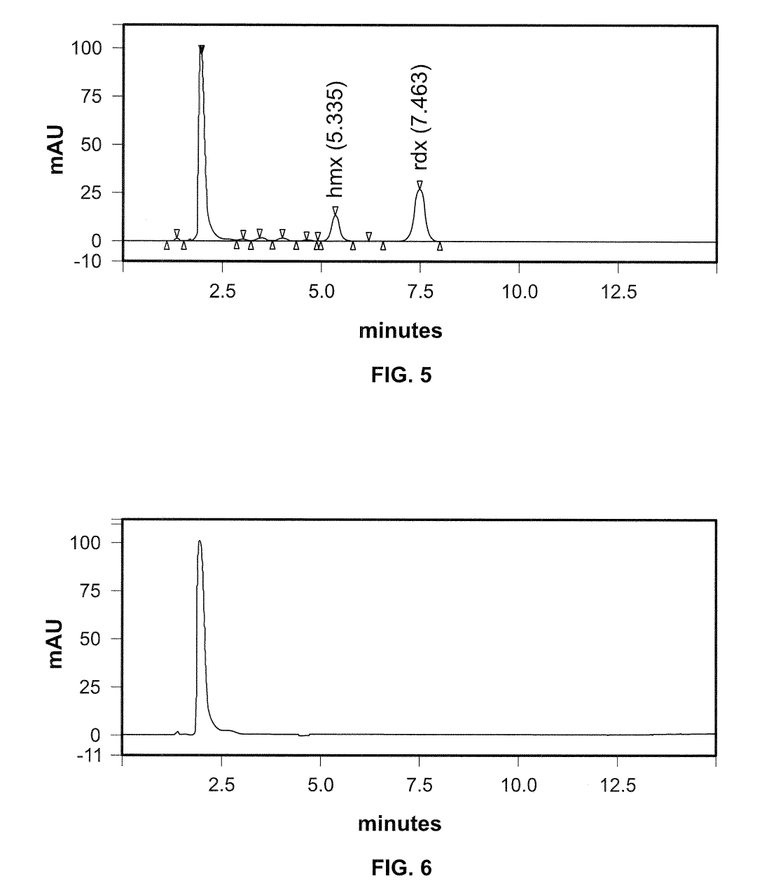

FIGS. 5 and 6 are chromatograms of untreated and treated water, respectively, from a batch test conducted according to the exemplary method described above. The chromatogram of FIG. 5 represents the composition of the “feed” sample. The treated sample was collected at the conclusion of the treatment. It can be seen that the peaks in FIG. 5 that are attributable to RDX and HMX are absent from FIG. 6.

The tall peak visible near the left side of each figure is attributable to the acetic acid in the samples.

### Example 2

### Bench Scale Tests of RDX Removal

A sample of the Holston water was acidified to a pH of between 3.5 and 4.0 with dilute acetic acid. A 600 mg portion of bimetallic ZVI/copper particles prepared as described above were weighed into each of two 60 mL test tubes. The test tubes were then filled with the acifidied water to produce duplicate samples having about 1% bimetallic particles by weight, and capped with a valve. The test tubes were shaken to disperse the particles, then agitated in a rotator. Samples of 1.5 mL each were taken at contact times of 0, 1, 2, 5, 10, 20, 30, 40 and 60 minutes through the valves, using a syringe. The samples were immediately filtered, and the first 0.5 mL of each filtrate was discarded. The remainder of each filtrate was analyzed by HPLC.

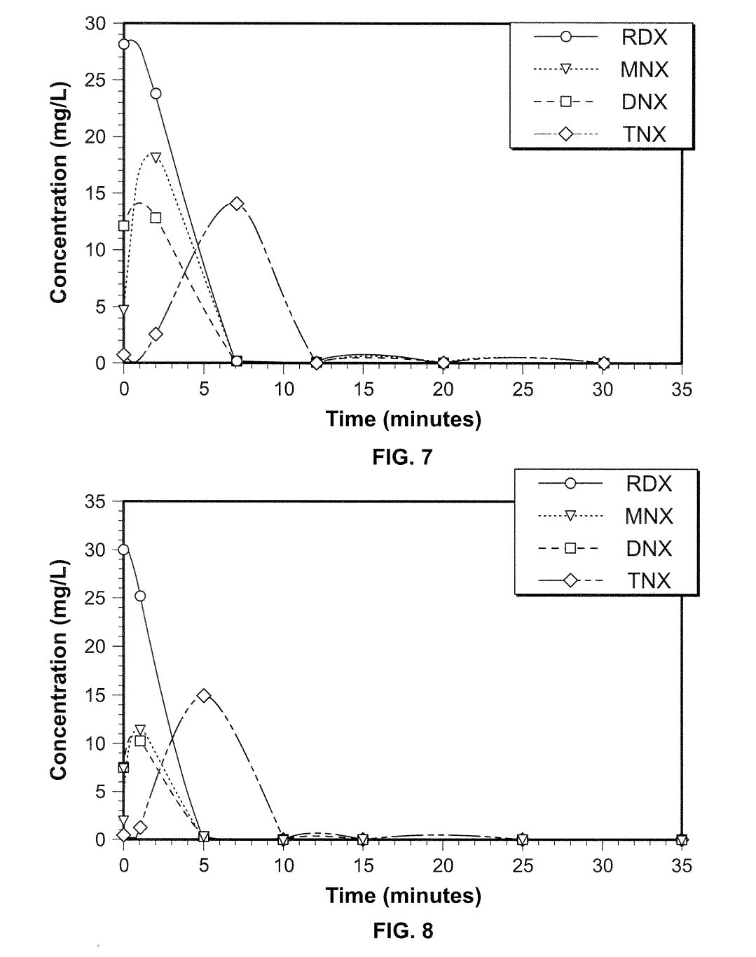

FIGS. 7 and 8 are graphs of the concentrations of RDX and its reduction products TNX, DNX and MNX over time in respective duplicate samples. RDX and its reduction products were removed to undetectable levels after about 30 minutes of contact with the bimetallic particles. The plots of TNX, DNX and MNX concentrations show the formation and subsequent removal of these compounds.

### Example 3

### Bench Scale Test of TNT, RDX and HDX Removal

A sample of waste water from explosives processing at the Picatinny Arsenal in Dover, N.J. (also known as “pink water”) was treated in a bench scale test following a test protocol similar to that in Example 2. The pink water, as received, contained RDX at 36.37 mg/L, HMX at 4.98 gm/L and TNT at 46.20 gm/L. Other chemicals, such as perchlorate, were also present. Each of two test tubes received 60 mL of pink water and 3% bimetallic ZVI/copper particles by weight of solution. The pink water, which had an initial pH of about 3.6, was adjusted to a pH value of about 3 by adding acetic acid to each test tube. The test tubes were agitated to ensure thorough contact between the particles and the acidified water. Samples were collected from each test tube at contact times of 0, 1, 2, 5, 7, 10, 12, 15, 20 and 30 minutes, filtered, and analyzed by HPLC. Untreated control samples were collected and analyzed as the treated samples.

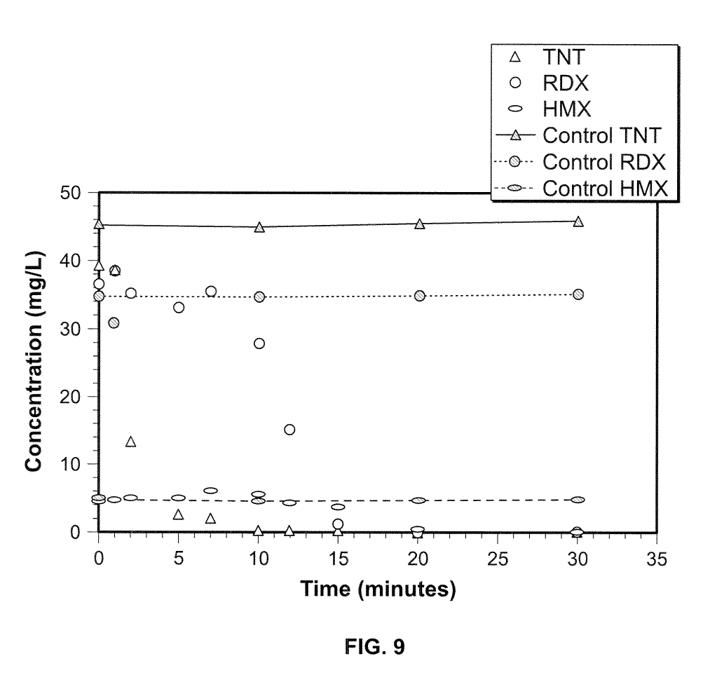

FIG. 9 is a plot of the removal of TNT, RDX and HDX over time in each of the test tubes. Each of the compounds was completely removed from the treated water sample before 30 minutes had elapsed. The concentrations of each compound in the untreated sample remained constant over that time.

It should be understood that the embodiments described herein and in the attached Exhibits are merely exemplary and that a person skilled in the art may make many variations and modifications thereto without departing from the spirit and scope of the present invention. All such variations and modifications, including those discussed above, are intended to be included within the scope of the invention as exemplified by the following claims.

We claim:

1. A method of treating water to degrade organic nitro compounds therein, said method comprising the steps of:
contacting said water with bimetallic particles comprising cores of zero-valent iron having discontinuous coatings of metallic copper on their surfaces; and
separating the bimetallic particles from the water.

2. The method of claim 1, including the further step of acidifying the water to a pH between about 3.0 and about 4.5 before and/or during said contacting step.

3. The method of claim 2, wherein said acidifying step includes the step of adding acetic acid to the water.

4. The method of claim 1, including the step of selecting bimetallic particles comprising cores of zero-valent iron having discontinuous coatings of metallic copper on their surfaces before said contacting step, the bimetallic particles so selected having a particle size and copper content sufficient to degrade substantially all of the organic nitro compounds present in the water within 30 minutes after said contacting step is initiated, the contacting step being performed so that the bimetallic particles so selected are present in the water at a quantity in the range of about 0.25 to about 4.0% by weight of the water.

5. The method of claim 4, wherein the bimetallic particles have diameters in the range of about 5 to about 500 microns.

6. The method of claim 4, wherein the bimetallic particles have copper content in the range of about 5 to about 20 grams of copper for each 100 grams of zero-valent iron.

7. The method of claim 1, wherein the coating of metallic copper on the surfaces of the zero-valent iron cores includes islands of metallic copper.

8. The method of claim 1, wherein said contacting step is performed so as to minimize the formation of iron oxides on the surface of the zero-valent iron core.

9. The method of claim 1, wherein said contacting step includes the step of agitating the water so as to suspend the bimetallic particles therein.

10. The method of claim 1, wherein said contacting step includes the step of passing the water through a bed of the bimetallic particles.

11. The method of claim 10, wherein said passing step is performed so as to fluidize the bed of bimetallic particles.

12. The method of claim 1, including the further step of washing the bimetallic particles with water having a pH of less than about 4.5 so as to remove iron oxides from the surfaces of the bimetallic particles after the separating step.

13. The method of claim 1, wherein said separating step includes the step of allowing the bimetallic particles to settle.

14. The method of claim 1, wherein said separating step includes the step of filtering the bimetallic particles out of the water.

15. The method of claim 1, wherein said separating step is performed using a vortex separator.
